(19) United States
(12) Patent Application Publication
(10) Pub. No.: US 2009/0057941 A1
(43) Pub. Date: Mar. 5, 2009

(54) Method for manufacturing synthetic leatherette possessing properties of high elasticity, abrasion resistance and environmental friendliness

(75) Inventors: Chien-Hsing Yeh, Taichung (TW); Shih-Yen Wang, Taichung (TW)

Correspondence Address: CHARLES E. BAXLEY, ESQUIRE, 90 JOHN STREET, SUITE 309, NEW YORK, NY, 10038, US

(73) Assignee: Antee Enterprise Co., Ltd.

(21) Appl. No.: 11/897,817

(22) Filed: Aug. 31, 2007

(51) Int. Cl. B29C 41/32

(52) U.S. Cl. 264/78; 264/175

(57) ABSTRACT

A method for manufacturing a synthetic leatherette that possesses properties of high elasticity, abrasion resistance and environmental friendliness, comprises following steps: melting grains of Thermoplastic Elastomer (TPE) in a melting pot into a TPE melt with heat; mixing the TPE melt into an even TPE liquid; sheeting the TPE liquid into a TPE layer with a heat pressing roller; laminating the TPE layer with a reinforcement material layer with heat; cooling the TPE layer laminated with the reinforcement material layer with a cooling rooler; and reheating the cooled TPE layer laminated with the reinforcement material layer in a oven for finalize the synthetic leatherette. In industrial applications, the disclosed synthetic leatherette made of TPE is advantaged by being innocuous, without uncomfortable odor, decomposable, completely recyclable, highly elastic, highly wear-resistant, and light. Thereupon, the resultant synthetic leatherette of the present invention is applicable to a more extensive scope of industries as compared with the traditional PU leatherette.

### BACKGROUND OF THE INVENTION

1. Technical Field

The present invention relates to leatherette, and more particularly to a method for manufacturing a synthetic leatherette possessing properties of high elasticity, abrasion resistance and environmental friendliness.

2. Description of Related Art

Generally speaking, all leather-like materials made form PVC (polyvinyl chloride) or PU (Poly Urethane) that simulating genuine leather are known as leatherette, imitation leather fabric or synthetic leather.

Therein, PVC leatherette is the first ersatz invented for substituting for genuine leather. It is made by rolling PVC (polyvinyl chloride), plasticizer and other agents on fabrics. Though inexpensiveness would be one advantage thereof, PVC leatherette detrimentally has a higher compression set and therefore is liable to become embrittled and hardened soon after being produced.

Then PU leatherette has been developed to remedy the drawback of PVC leatherette. As such, PU leatherette possesses a chemical structure more similar to that of the genuine leather and the softness thereof requires no plasticizer. Thus, PU leatherette is extensively accepted in the market.

However, with the rise of environmental consciousness, the environmental issue about the traditional plastic products comes to people's concern again. Leatherettes made from PVC and PU is unfavorable to recycling and can no be naturally dissolved when being buried in the ground. Moreover, the traditional leatherette materials generate toxic wastes when being burned. Consequently, the traditional leatherettes are not only detrimental to economic efficiency, but also baneful to human health and natural environment.

Meanwhile, though PU, as compared with PVC, provides a texture closer to that of the genuine leather, the molecular structure thereof may become loosen after a long-term storage, resulting in brittleness of the PU products. Besides, since the hydrolysis resistance of PU is not excellent, the usage thereof is limited.

Hence, the need exists for a novel leather substitute that meets the eco-concerned requirements and possesses improved physical properties.

### SUMMARY OF THE INVENTION

The present invention has been accomplished under these circumstances in view to provide a method for manufacturing a synthetic leatherette that possesses properties of high elasticity, abrasion resistance and environmental friendliness, and is made of Thermoplastic Elastomer (TPE).

It is one objective of the present invention to provide a method for manufacturing a synthetic leatherette that is recyclable. Since the disclosed synthetic leatherette is made of recyclable Thermoplastic Elastomer, the waste generated in the production, such as deckle edges and extruded waste of TPE material, and the spoiled products can be recycled directly. Even the used TPE products can be recycled after simple treatment. Therefore, the present invention facilitates reducing waste of resources and trash thereby reducing manufacturing cost, enhancing economic benefit and conducing to environmental protection.

It is another objective of the present invention to provide a method for manufacturing a synthetic leatherette that is safe to human. As neither noxious gas nor fetor is generated during the production of the disclosed synthetic leatherette, the manufacturing workers is protected from being affected by hazardous materials.

It is another objective of the present invention to provide a method for manufacturing a synthetic leatherette that is friendly to Nature. Since the disclosed synthetic leatherette is innocuous, when being burned, it does not incur materials harmful to the environment. Besides, unlike the traditional leatherette which does not decompose naturally and thus cause burden to the environment, the disclosed synthetic leatherette is decomposable when being buried in the ground. Hence, the disclosed synthetic leatherette requires no special waste treatment system or procedure and facilitates saving the costs of waste treatment.

It is another objective of the present invention to provide a method for manufacturing a synthetic leatherette that is more acceptable to the consumers. As compared with the traditional leatherette, the disclosed synthetic leatherette is innocuous and without uncomfortable odor, so that the disclosed synthetic leatherette leads to higher user acceptance.

It is yet another objective of the present invention to provide a method for manufacturing a synthetic leatherette that possesses improved physical properties. As compared with the traditional leatherette, the disclosed synthetic leatherette made of TPE is advantaged by being innocuous, without uncomfortable odor, decomposable, completely recyclable, highly elastic, highly wear-resistant, and light. Thereupon, the resultant synthetic leatherette of the present invention is applicable to a more extensive scope of industries as compared with the traditional PU leatherette.

It is still another objective of the present invention to provide a method for manufacturing a synthetic leatherette that can be manufacture with existing TPE machines and simplified procedures. For manufacturing traditional PU leatherette, laminating machine and smearing machine are required to conduct complicated laminating and smearing procedures. However, the disclosed synthetic leatherette can be manufactured by existing machines in a normal TPE factory. Thus, the present invention can significantly save the cost for purchasing manufacturing facilities.

### BRIEF DESCRIPTION OF THE DRAWINGS

The invention as well as a preferred mode of use, further objectives and advantages thereof, will best be understood by reference to the following detailed description of an illustrative embodiment when read in conjunction with the accompanying drawings, wherein:

FIG. 1 is a flow chart showing the method for manufacturing the disclosed synthetic leatherette that possesses properties of high elasticity, abrasion resistance and environmental friendliness,

FIG. 2 is a schematic drawing illustrating the step of laminating the TPE layer with the reinforcement material layer;

FIG. 3 is a perspective view of the TPE layer made through the method of FIG. 1;

FIG. 4 is a perspective view of the disclosed synthetic leatherette made through the methods of FIGS. 1 and 2;

FIG. 5 is a flow chart showing the step of forming the artificial pattern;

FIG. 6 is a flow schematic drawing illustrating the step of forming the artificial pattern;

FIG. 7 is a flow chart showing the step of forming the leather texture; and

FIG. 8 is a perspective view of the disclosed synthetic leatherette formed with the leather texture.

### DETAILED DESCRIPTION OF THE PREFERRED EMBODIMENT

One major concept of the present invention is to utilize Thermoplastic Elastomer (TPE) to supersede conventionally used PVC (polyvinyl chloride) or PU (poly urethane) as a material to manufacture a novel synthetic leatherette that possesses properties of high elasticity, abrasion resistance and environmental friendliness.

Thermoplastic Elastomer (TPE) is also known as Thermoplastic Rubber (TPR) and possess both rubber-like and thermo plastic-like properties. When in the normal atmospheric temperature, TPE performs excellent elasticity as that of rubber while under high heat, it can be processed and recycled like plastic does. Thus, TPE, as such, is a novel high tech material. The inventor of the present invention applies this novel material to the manufacture of synthetic leatherette so as to provide a synthetic leatherette that possesses properties of high elasticity, abrasion resistance and environmental friendliness.

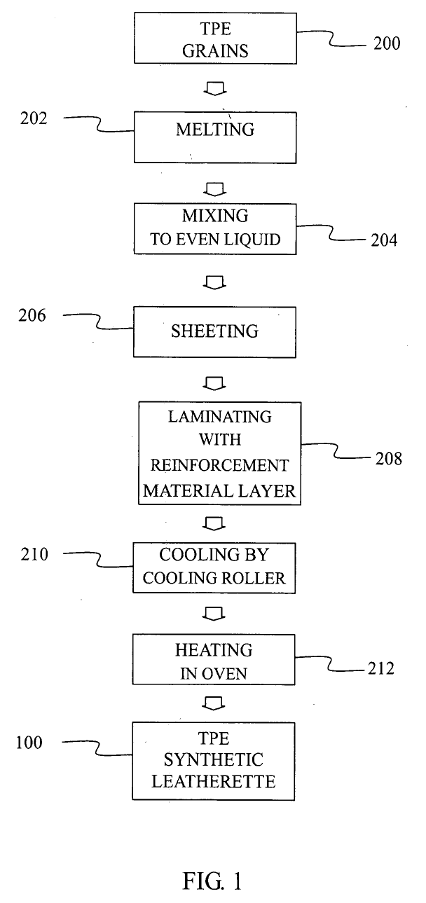

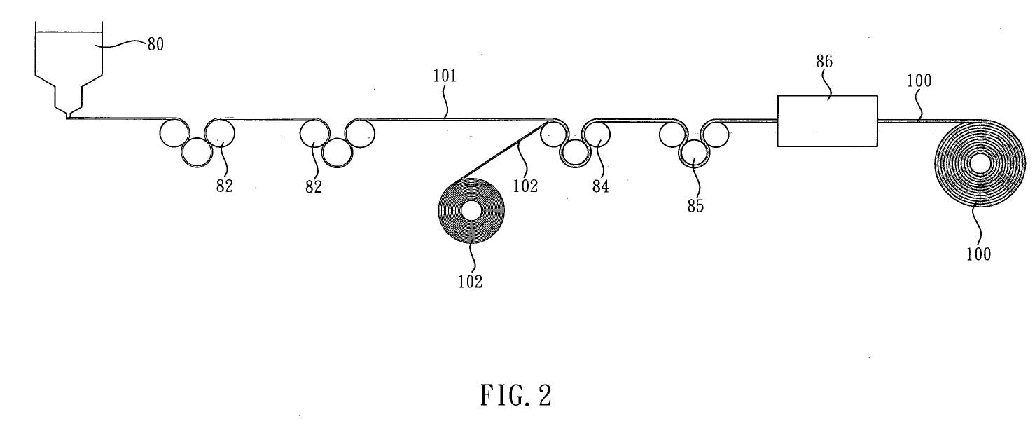

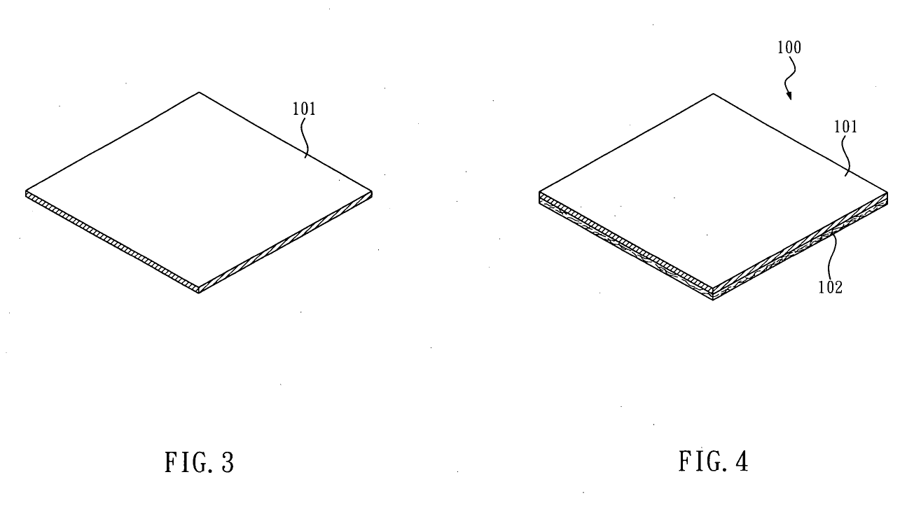

The method for manufacturing the synthetic leatherette of the present invention as described above primarily comprises the steps illustrated in FIGS. 1 and 2. Therein, grains of Thermoplastic Elastomer (TPE) are placed in a melting pot 80 (Step 200) firstly for being melted (Step 202). The melted TPE is then well mixed into an even TPE liquid (Step 204). In Step 206, the TPE liquid is extruded and sheeted by a heat pressing roller 82 into a TPE layer 101, as shown in FIG. 3. A heat laminating roller 84 is implemented to laminate the TPE layer 101 with a reinforcement material layer 102 and makes the both combine with each other closely (Step 208). Afterward, the TPE layer 101 laminated with the reinforcement material layer 102 is treated with a cooling roller 85 so as to make the TPE layer 101 and reinforcement material layer 102 fixedly bind mutually (Step 210).

The reinforcement material layer 102 may be Tetoron cotton blended fabrics, 100% polyester fabrics, 100% cotton fabrics, PVC (polyvinyl chloride) fabrics, 100% Nylon fabrics, PP (poly propylene) fabrics, Nylon/Tetoron cotton blended fabrics, fiberglass fabrics, carbon fabrics or a combination of any of the above fabrics, and functions for providing the TPE layer 101 with a light and pliable but strong foundation. At last, the cooled semi-product is reheating in an oven 86 so that the combination between TPE layer 101 and the reinforcement material layer 102 is further enhanced (Step 212). Thereupon, the disclosed synthetic leatherette 100 that possesses properties of high elasticity, abrasion resistance and environmental friendliness is finalized, as shown in FIG. 4.

According to the examination report on the disclosed synthetic leatherette issued by SGS Far East Ltd., Taiwan, the TPE synthetic leatherette 100 of the present invention has passed all Toxicity Tests and is proven as innocuous. (No lead, cadmium, mercury, Hexavalent Chromium, copper, nickel, antimony, arsenic, cobalt, PAHs, Organic Tin Compounds, PCB, PBBs or PBDEs was detected.) Besides, through Material Physical Properties Test that was also conducted by SGS Far East Ltd., Taiwan, as compared with traditional PU leatherette, the synthetic leatherette 100 of the present invention has relatively higher tensility, tongue tear-resistance, and ductility.

The test results of the traditional PU leatherette and the synthetic leatherette 100 of the present invention are described in Table 1 and Table 2.

TABLE 1
The results of tensile and elongation tests on TPE
Synthetic Leatherette and Traditional PU Leatherette

| | THICKNESS | WEIGHT | TENSILE KG/2.54 CM | | ELONGATION % | |
|---|---|---|---|---|---|---|
| ITEM | mm | g/m2 | VERTICAL | HORIZONTAL | VERTICAL | HORIZONTAL |
| TPE | 1.05 | 623 | 31 | 31 | 70 | 111 |
| Synthetic | | | | | | |
| Leatherette | | | | | | |
| Traditional | 1.15 | 686 | 25 | 24 | 54 | 93 |
| PU | | | | | | |
| Leatherette | | | | | | |
| Traditional | 1.15 | 686 | 25 | 24 | 54 | 93 |
| PU | | | | | | |
| Leatherette | | | | | | |

TABLE 2
The results of tongue tear and stoll tests on TPE Synthetic
Leatherette and Traditional PU Leatherette

| | | | TONGUE TEAR | | STOLL | |
|---|---|---|---|---|---|---|
| | THICKNESS | WEIGHT | Kg | | 1.0LB#TOP | 0.5LB#TOP |
| ITEM | mm | g/m2 | VERTICAL | HORIZONTAL | WT./FACE | WT./BACK |

| | | | | | |
|---|---|---|---|---|---|
| TPE | 1.03 | 536 | 9.4 | 11 | 1150 − (1140+)PSI6.1 |
| Synthetic | | | | | |
| Leatherette | | | | | |
| Traditional | 1.15 | 686 | 9.3 | 9.7 | 600 − (590+)PSI6.1 |
| PU | | | | | |
| Leatherette | | | | | |

Hence, the disclosed synthetic leatherette made of TPE is advantaged by being innocuous, without uncomfortable odor, decomposable, completely recyclable, highly elastic, highly wear-resistant, and light. Thereupon, the resultant synthetic leatherette of the present invention is applicable to a more extensive scope of industries as compared with the traditional PU leatherette.

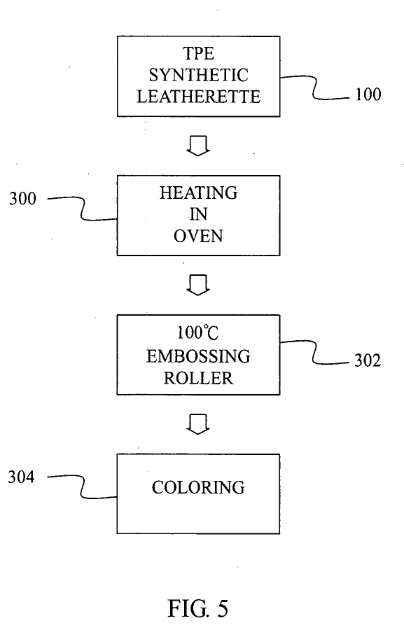

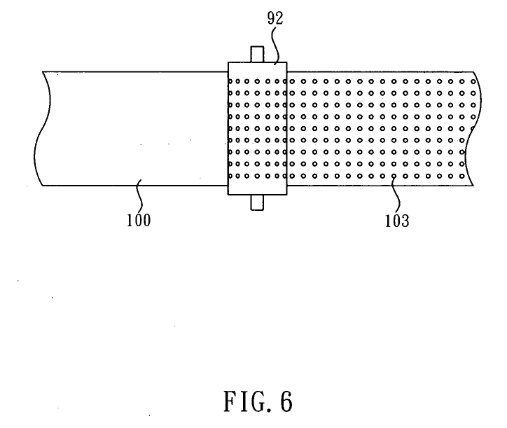

According to one, embodiment of the present invention, after the finalized synthetic leatherette 100 is cooled to a normal atmospheric temperature, a step of forming an artificial pattern thereon as illustrated in FIGS. 5 and 6 may be conducted. The step of forming the artificial pattern includes heating the synthetic leatherette 100 in an oven (Step 300). Then an embossing roller 92 that is pre-heated to 100° C. is implemented to form a predetermined pattern, for example, a basketball texture 103, as shown in FIG. 6, at an outer surface of the synthetic leatherette 100 (Step 302). The synthetic leatherette 100 embossed with the basketball texture 103 can later be colored by any known means in the art, such as pigment coating or pigment pad dyeing (Step 304) so that the appeared color of the synthetic leatherette 100 can be changed to meet the practical needs.

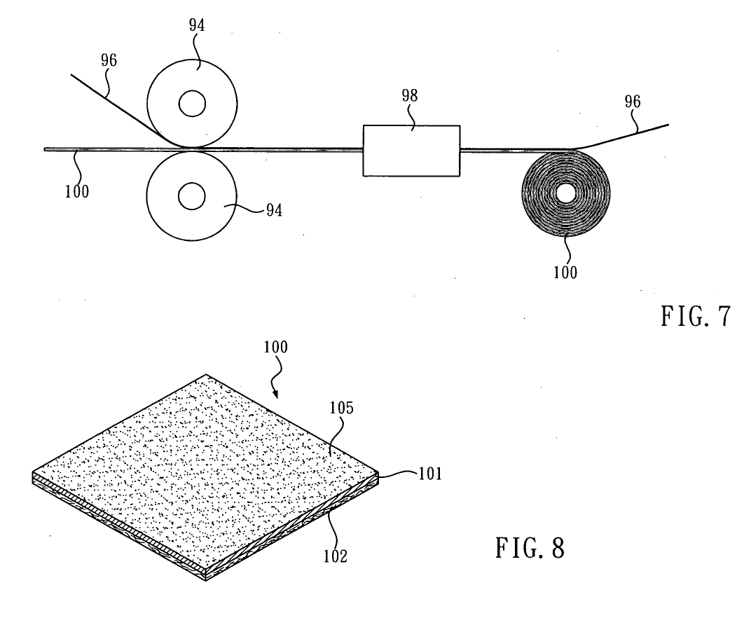

Alternatively, according to another concept of the present invention, after the finalized synthetic leatherette 100 is cooled to a normal atmospheric temperature, a step of forming a leather texture thereon with a release film 96 as illustrated in FIG. 7 may be conducted. The step of forming the leather texture includes placing the release film 96 on the outer surface of the TPE layer 101 of the synthetic leatherette 100; pressing the release film 96 and the TPE layer 101 together with a pair of pressing roller 94; heating the synthetic leatherette 100 combined with the release film 96 in an oven 98; cooling the heated synthetic leatherette 100 combined with the release film 96 to a normal atmospheric temperature; and removing the release film 96 from the outer surface of the TPE layer 101, so as to form the leather texture 105 as shown in FIG. 8 on the outer surface of the TPE layer 101.

Although a particular embodiment of the invention has been described in detail for purposes of illustration, it will be understood by one of ordinary skill in the art that numerous variations will be possible to the disclosed embodiments without going outside the scope of the invention as disclosed in the claims.

What is claimed is:

1. A method for manufacturing a synthetic leatherette that possesses properties of high elasticity, abrasion resistance and environmental friendliness, comprising following steps:
melting grains of Thermoplastic Elastomer (TPE) into a TPE melt with heat;
mixing the TPE melt into an even TPE liquid;
sheeting the TPE liquid into a TPE layer;
laminating the TPE layer with a reinforcement material layer with heat;
cooling the TPE layer laminated with the reinforcement material layer; and
reheating the cooled TPE layer laminated with the reinforcement material layer for finalize the synthetic leatherette.

2. The method of claim 1, wherein the reinforcement material layer is made of Tetoron cotton blended fabrics, 100% polyester fabrics, 100% cotton fabrics, PVC (polyvinyl chloride) fabrics, 100% Nylon fabrics, PP (poly propylene) fabrics, Nylon/Tetoron cotton blended fabrics, fiberglass fabrics, carbon fabrics or a combination of any of the above fabrics

3. The method of claim 1, further comprising steps of cooling the finalized synthetic leatherette to a normal atmospheric temperature and coloring the same.

4. The method of claim 1, further comprising steps of cooling the finalized synthetic leatherette to a normal atmospheric temperature and forming an artificial pattern on the same.

5. The method of claim 1, further comprising steps of cooling the finalized synthetic leatherette to a normal atmospheric temperature and embossing the same, wherein the step of embossing is realized by using an embossing roller that is pre-heated to 100° C.

6. The method of claim 1, further comprising steps of cooling the finalized synthetic leatherette to a normal atmospheric temperature and forming a leather texture on the same.

7. The method of claim 1, further comprising steps of cooling the finalized synthetic leatherette to a normal atmospheric temperature and heat transfer printing the same with a release film, wherein the step of heat transfer printing comprises:
placing the release film on an outer surface of the TPE layer;
pressing the release film and the TPE layer together;
heating the synthetic leatherette combined with the release film in an oven;
cooling the heated synthetic leatherette combined with the release film to a normal atmospheric temperature; and
removing the release film from the outer surface of the TPE layer.
